(19) United States
(12) Patent Application Publication
(10) Pub. No.: US 2012/0327837 A1
(43) Pub. Date: Dec. 27, 2012

(54) METHOD, APPARATUS AND SYSTEM FOR PROVIDING EMERGENCY ALERTS TO MOBILE DEVICES

(75) Inventors: Michael Neil Harrington, Raleigh, NC (US); Matthew W. Jones, Apex, NC (US); Akita Noek, Durham, NC (US)

(73) Assignee: VELLEROS, INC., Morrisville, NC (US)

(21) Appl. No.: 13/532,284

(22) Filed: Jun. 25, 2012

Related U.S. Application Data
(60) Provisional application No. 61/500,638, filed on Jun. 24, 2011.

(51) Int. Cl. H04W 4/00

(52) U.S. Cl. 370/312

(57) ABSTRACT

A method of providing emergency alerts to a plurality of user devices is provided. A gateway device determines, for each of the plurality of user devices, a network address that uniquely corresponds to the user device. An emergency alert associated with a predetermined region is determined. A subset of the plurality of user devices located substantially in the predetermined region is determined. The emergency alert is then provided to the subset of the plurality of user devices located substantially in the predetermined region via the network addresses of the subset of the plurality of user devices.

### RELATED APPLICATIONS

This application claims the benefit of U.S. provisional patent application No. 61/500,638, filed Jun. 24, 2011, the disclosure of which is hereby incorporated herein by reference in its entirety.

### FIELD OF THE DISCLOSURE

This disclosure relates to the field of providing emergency alerts to mobile devices, for example, distributing Commercial Mobile Alerting System (CMAS) emergency messages as part of an Integrated Public Alert and Warning System (IPAWS) compliant distribution plan.

### BACKGROUND

The Federal Communication Commission (FCC) and Federal Emergency Management Agency (FEMA) have defined CMAS as a means to distribute through Commercial Mobile Service Providers (CMSPs) emergency alerts aggregated into the IPAWS network from local, state & federal facilities. In response to the CMAS initiative, the Cell Broadcast protocol was adopted by U.S. mobile carriers for delivering Commercial Mobile Alert Messages (CMAMs) through CMAS.

Cell Broadcast has a number of drawbacks. In particular, Cell Broadcast enabled devices which support Wireless Emergency Alerts (WEA) via CMAS are rare and therefore consumer participation is extremely low. The severely limited device availability coupled with the significant deployment costs to activate Cell Broadcast within the wireless switching gear and radio network creates a significant disincentive for CMSPs to deploy this critical, lifesaving CMAS Emergency Alerting Service. Furthermore, some CMSP networks will not support Cell Broadcast and therefore, leave carriers on the CMSP unable to provide CMAS service to their subscribers. This is a significant competitive disadvantage to such carriers. Thus, there is a need for an alternative and/or supplemental method for disseminating CMAMs. One alternative is to use the existing network infrastructure to distribute Short Message Service (SMS) messages (i.e., text messages) to affected handsets. However, a situation necessitating the dissemination of a CMAM could result in an overly large number of simultaneous or near-simultaneous SMS transmissions, which could create a potentially crippling load on the CMSP's network. Furthermore, SMS delivery is not conducive to providing geotargeted emergency alerting. Since county level geotargeting is an FCC requirement for CMAS, SMS delivery of CMAMs is not feasible in most situations.

In addition, there is a greater possibility that an emergency SMS message could be overlooked, because an emergency SMS message would not necessarily be treated any differently by the user device than any other SMS message. Because the CMAS standard requires, among other things, a CMAM notification to trigger distinctive audible and vibration cadences, CMAM delivery via SMS is difficult to implement.

Finally, CMSPs are generally not equipped to provide mass SMS or other messages to user devices that are not subscribed to the CMSP's network, even if the user device is otherwise connected to the CMSP's network, such as when the user device is roaming on another CMSP network.

Accordingly, there is a need for delivering CMAMs and other emergency alerts over existing infrastructures in a way that will avoid the cost, capacity, complexity and notification issues described above, while ensuring that the messages are received by as many users in an affected region as possible, including users that are not subscribed to a CMSP's network.

### SUMMARY

Embodiments of the present disclosure employ a CMSP's data network and location determination capabilities to identify user devices that are within an affected area, and to provide a CMAM or other emergency alert to these user devices via an Internet Protocol (IP) network, for example through a smartphone application or other software function. One advantage of this arrangement is that network load required for IP distribution of a comparable emergency alert is significantly less than SMS distribution. In addition, even if a particular CMSP that is sending the emergency alert does not provide its own data connection to the user device, the CMSP can still identify an affected user device by its connection to the CMSP's network via a CMSP's wireless node (e.g., cellular tower, femtocell, etc.) and provide the emergency alert to the device via an alternative wireless node such as the user's own CMSP network, Wi-Fi hotspot or other node having Internet connectivity.

An exemplary embodiment includes a method, apparatus and system for providing emergency alerts to a plurality of user devices. In one embodiment, a gateway device, such as a CMSP gateway, determines, for each of a plurality of user devices, a network address that uniquely corresponds to the user device, determines an emergency alert associated with a predetermined region, and determines a subset of the plurality of user devices located substantially in the predetermined region. The emergency alert is then provided to the subset of the plurality of user devices located substantially in the predetermined region via the network addresses of the subset of the plurality of user devices.

In one embodiment, providing the emergency alert includes transmitting the emergency alert in the same 90 character text format as Cell Broadcast distribution methods except that it is delivered to the user device via an Internet Protocol (IP) network. Providing the emergency alert may also include transmitting the same emergency alert in a more informative and user friendly format (including, but not limited to, full text descriptions, images, audio, video, multimedia, etc.) to the user device via the Internet Protocol (IP) network, either as a supplement to, or if supported by the FEMA Federal Alert Gateway, as an alternative to the limited and relatively cryptic 90 character format dictated by Cell Broadcast limitations.

In one embodiment, it is determined whether each user device is in wireless communication with the IP network, and providing the emergency alert may be in response to this determination. The emergency alert can also be provided via a non-IP network, for example, if it is determined that the user device is not in wireless communication with the IP network. The emergency alert can also be provided via both an IP and a non-IP network simultaneously. For example, in one embodiment, the emergency alert is provided via Cell Broadcast in addition to delivery of the emergency alert via the IP network.

In one embodiment, determining the subset of the plurality of user devices located substantially in the predetermined region includes determining a location of each user device based on location data obtained from the user device. This determination can include determining whether each user device is within a predetermined distance of a location of at least one wireless node, such as a cellular tower or a wireless access point. In this example, proximity to the wireless node can be determined based on whether the user device is in wireless communication with the at least one wireless node. In another embodiment, the user device can determine whether to receive the emergency alert via an IP and/or non-IP protocol, based on the availability of the IP and/or non-IP network.

In one embodiment, the predetermined region is selected from a plurality of regions having substantially equal sizes and shapes. In one embodiment, the plurality of regions is arranged in a staggered grid pattern.

In one embodiment, the emergency alert is a CMAS alert, i.e., a CMAM.

In one embodiment, providing the emergency alert to the user device via an Internet protocol (IP) network includes transmitting the emergency alert to the user device via a push protocol. In another embodiment, providing the emergency alert can include receiving a periodic poll request from the user device, and transmitting the emergency alert to the user device in response to the poll request. In another embodiment, providing the emergency alert can be delivered by IP Multicast, for example, when a subscriber joins a multicast based on a location.

In one embodiment, providing the emergency alert to the subset of the plurality of user devices is performed by a wireless carrier or other entity on behalf of a carrier, and includes providing the emergency alert to one or more user devices that are not subscribed to the wireless carrier.

Another embodiment includes a method and apparatus for receiving an emergency alert at a user device. In response to a determination at a gateway device, such as a CMSP gateway, that a subset of a plurality of user devices is located in a predetermined region, each of the plurality of user devices having a network address uniquely associated with the user device, an emergency alert is received via an Internet Protocol (IP) network. The emergency alert is associated with the predetermined region and is transmitted by the gateway device via the IP network to the subset of the plurality of user devices. Transmitting the emergency alert can be in response to the determination that the subset of the plurality of user devices is located in the predetermined region.

In one embodiment, the determination that the subset of the plurality of user devices is located in the predetermined region is performed based on location data received from the subset of the plurality of user devices. In one embodiment, the location data corresponds to the location of the subset of the plurality of user devices.

In one embodiment, the determination that the subset of the plurality of user devices is located in the predetermined region is performed based on a determination that each of the subset of the plurality of user devices is within a predetermined distance of a location of a wireless node.

In one embodiment, the emergency alert is received by the subset of the plurality of user devices in the same 90 character format as used in CMAS Cell Broadcast distributions.

In one embodiment, the emergency alert is received from a wireless carrier to which the user device is not subscribed. In another embodiment, the emergency alert is received from a wireless carrier by a user device located outside of the wireless carrier's service area.

Another embodiment includes a method and apparatus for receiving an emergency alert at a user device including receiving, via an Internet Protocol (IP) network, an emergency alert associated with a predetermined region that is transmitted by a gateway device, such as a CMSP gateway, via the IP network to a plurality of user devices. Each user device then determines whether the user device is located in the predetermined region, and provides the emergency alert to a user of the user device in response to the determination.

In one embodiment, determining whether the user device is located in the predetermined region includes receiving information from the gateway device identifying the predetermined region, such as a list of wireless nodes located in the predetermined region.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a system for providing emergency alerts to a plurality of user devices, according to an exemplary embodiment.

FIG. 2 illustrates a method for providing emergency alerts to a plurality of user devices, according to an exemplary embodiment.

FIGS. 3A-3C illustrate the determination of a region to which an emergency alert is to be provided, according to an exemplary embodiment.

FIG. 4 illustrates a device for providing emergency alerts to a plurality of user devices, according to an exemplary embodiment.

FIG. 5 illustrates a user device for receiving emergency alerts provided to a plurality of user devices, according to an exemplary embodiment.

FIGS. 6A-6D illustrate an exemplary user interface for a user device according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Embodiments disclosed herein relate to providing emergency alerts to a plurality of user devices. Embodiments will be disclosed herein in the context of methods, systems and apparatuses, including computing devices. For purposes of illustration, computing device embodiments will be described in the context of a “gateway”, which, as described below, may comprise one or more computing devices having the functionality described herein. Based on the generated emergency alert, a plurality of outgoing messages may be generated and distributed to the plurality of destination addresses. The use of numeric adjectives such as “first,” “second,” “third,” and the like prior to a particular element, such as a network node, is for distinguishing between different elements, such as different network nodes, and are not intended to imply a particular order, a particular quantity, or a particular priority. For example, a first network node in a first communications network simply refers to a network node in that communications network, and not necessarily to the originating network node or destination network node. Similarly, a reference to a second network node in a second communications network is meant simply to distinguish the second network node from the first network node, and does not imply that the second communications network contains a first network node.

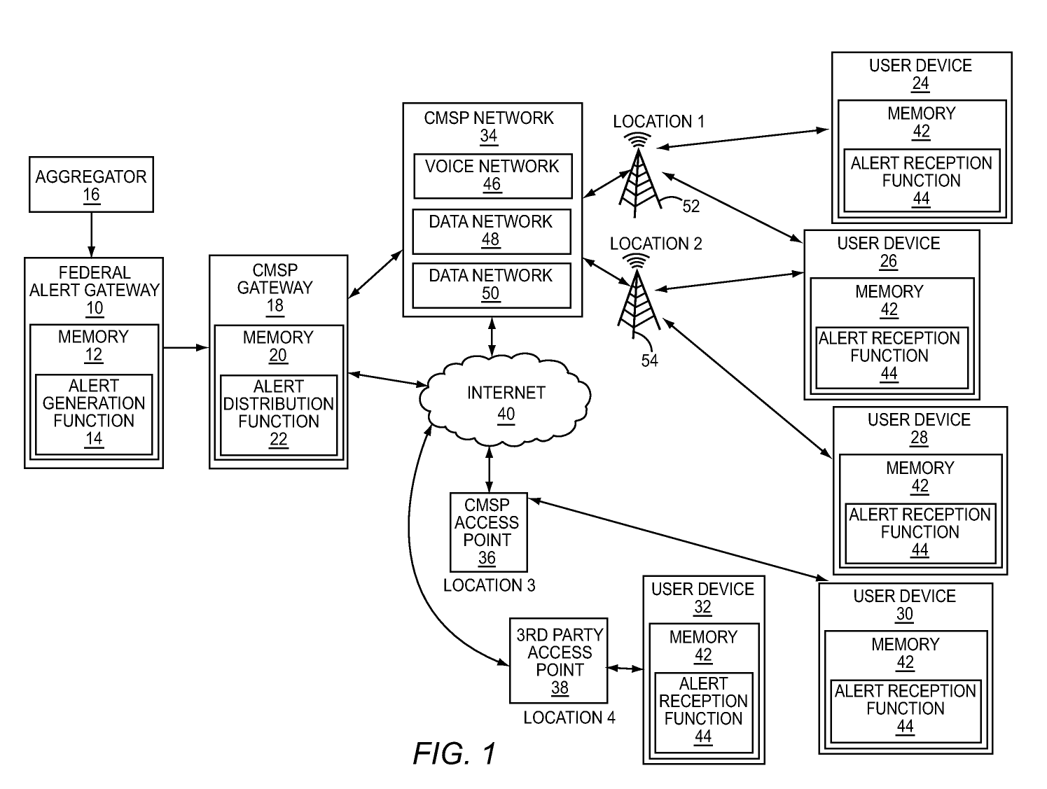

FIG. 1 illustrates a system for providing emergency alerts to a plurality of user devices, according to an exemplary embodiment. A Federal Alert Gateway 10 includes a memory 12 having an alert generation function 14. The alert generation function 14 of the Federal Alert Gateway 10 receives emergency information from a number of different sources via an aggregator 16 and generates emergency alerts, such as CMAMs, based on the received emergency information and relays the emergency alerts to one or more commercial mobile service provider (CMSP) gateways 18. Each CMSP gateway 18 includes one or more computing devices with an associated memory 20, which includes an alert distribution function 22. The alert distribution function 22 causes the CMSP gateway 18 to distribute the emergency alerts to a subset of a plurality of user devices 24, 26, 28, 30, 32 via Internet Protocol (IP) and other networks. The networks may include, for example, a CMSP network 34 such as an LTE, GSM, UMTS or CDMA network, one or more access points such as Wi-Fi hotspots and the networks of other CMSPs. The CMSP network 34 and access points 36, 38 can facilitate communication between the CMSP gateway 18 and the subset of the plurality of user devices 24, 26, 28, 30, 32 in different ways, such as direct connections to the CMSP gateway 18 via the CSMP's private infrastructure, and via Internet Protocol (IP) networks such as the Internet 40.

Each user device 24, 26, 28, 30, 32 includes a memory 42 having an alert reception function 44 configured to detect an incoming emergency alert sent from the CMSP gateway 18 and, in some embodiments, to determine whether to deliver the emergency alert to a user device. For example, in some embodiments, the emergency alert is provided based on a determined location of the user device 24, 26, 28, 30, 32.

In the embodiment shown in FIG. 1, for example, the CMSP network 34 includes a voice network 46 (e.g., GSM, CDMA) and two different data networks 48, 50 (e.g., GPRS, EDGE, EVDO, HSDPA, LTE, WiMax). It should be understood that the CMSP network 34 may include any number of voice and/or data networks. The CMSP network 34 receives the emergency alert and distributes the emergency alert to a plurality of wireless towers 52, 54. In this example, one tower 52 is at Location 1 and another tower 54 is at Location 2. Because the user device 24 is in communication with the tower 52, the location of the user device 24 can be estimated based on signal strength, range of the tower and other factors. In one example, upon registration with a new cell tower, the new CELL ID of the tower is converted to Longitude/Latitude coordinates. This conversion can utilize a Location Based Service (LBS) database in the network (e.g., an LBS cell tower database, etc.). Multiple methods may be utilized in the event the one or more methods are not available. The location of the user device 24 can be estimated with greater accuracy, such as with global positioning system (GPS) hardware associated with the user device 24, or can be estimated with less accuracy, such as assuming the user device 24 to have the same location as the tower 52. Thus, in this example, the user device 26 could be considered to be in Location 1 and Location 2 simultaneously, since the user device 26 is in simultaneous communication with the tower 52 and the tower 54. Likewise, the user device 28 could be considered to be in Location 2 because it is in communication with the tower 54, the user device 30 could be considered to be in Location 3 because it is in communication with the CMSP access point 36 (e.g., a CMSP femtocell), and the user device 32 could be considered to be in Location 4 because it is in communication with a third party access point 38. In some embodiments, once the location of the user device 32 has been determined, the user device 32 can be mapped, assigned or otherwise associated with a larger area or region, such as a state, county, city, zip code, grid sector or other predetermined or custom region.

In another embodiment, all user devices 24, 26, 28, 30, 32 in communication with the CMSP gateway 18 may receive the emergency alert and selectively display the emergency alert only if any of the user devices 24, 26, 28, 30, 32 determines that it is located within the affected area. In one embodiment, the emergency alert can be accompanied by a list of towers or other nodes in the affected area and only the user devices that are connected to the listed towers would display the emergency alert.

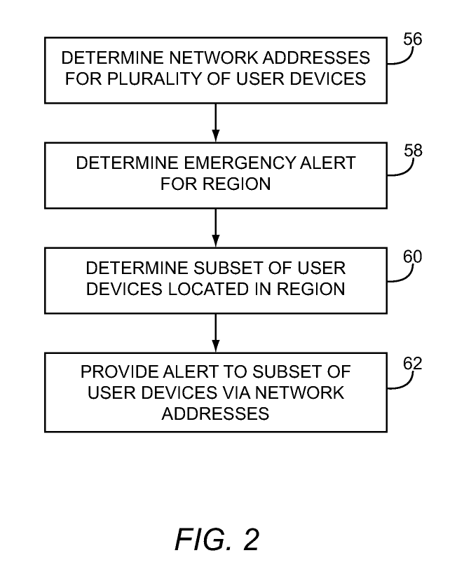

FIG. 2 illustrates a method for providing emergency alerts to a plurality of user devices, according to an exemplary embodiment. FIG. 2 will be discussed in conjunction with FIG. 1. First, a plurality of network addresses for a plurality of user devices is determined (block 56), for example by the CMSP gateway 18 (FIG. 1). Next, an emergency alert for a particular region is determined (block 58). In block 60, a subset of user devices located in the region is determined. Finally, the alert is provided to the subset of user devices, such as user devices 24, 26, 28, 30, 32 (FIG. 1), via the network addresses of the user devices (block 62).

Applying this method to the system of FIG. 1, the CMSP gateway 18 can determine the network addresses of the user devices 24, 26, 28, 30, 32 in a number of ways. For example, the CMSP gateway 18 can determine the network addresses of user devices 24, 26 and 28 via the CMSP network 34 and can determine the network address of user device 30 via CMSP access point 36. The CMSP gateway 18 can also determine the network address of any of user devices 24, 26, 28, 30, 32 directly or indirectly via the Internet 40, such as by a connection with a smartphone application or other software function.

For this example, assume that the Federal Alert Gateway 10 generates a CMAM that applies to a region that includes Locations 2, 3 and 4. The alert distribution function 22 of the CMSP gateway 18 can determine, based on the estimated locations of user devices 24, 26, 28, 30, 32, that user devices 26, 28, 30, 32 are located in the affected area. The CMSP gateway 18 is now able to distribute the emergency alert to the affected user devices 26, 28, 30, 32.

Notably, user device 32 is capable of receiving the emergency alert sent by the CMSP gateway 18, for example, via a smartphone application connected to the Internet 40, even though it is not directly connected to the CMSP network 34. For example, in one embodiment, a user device 32 may be subscribed to the CMSP associated with CMSP gateway 18 when the CMSP sends an emergency alert via the CMSP gateway 18. The user device 32 can be determined to be located within the affected area (i.e., at Location 4), even though it does not have a data connection via the CMSP network 34. For example, the user device 32 can determine its location from a known location of third party access point 38, such as another CMSP's tower or a Wi-Fi hotspot. The user device 32 may also be able to determine its location via an onboard global positioning system (GPS) unit. The user device 32 can attempt to use one or more of these location methods simultaneously or in sequence, based on factors such as battery load, network congestion, and other factors.

Although the user device 32 has been determined to be located within the affected area, the CMSP will be unable to deliver the emergency alert to user device 32 via Cell Broadcast because the user device 32 is not in communication with the CMSP network 34. Even if the user device is in communication with another CMSP's network, the user device 32 would not receive the emergency alert via Cell Broadcast unless that CMSP's network were also capable of providing Cell Broadcast messages and had sent out the same emergency alert via Cell Broadcast.

In this embodiment, however, the user device 32 has a data connection to the Internet 40 via the third party access point 38 which may comprise, for example, a cell tower of a different CMSP from the CMSP associated with the CMSP network 34. Thus, the CMSP to which the user device 32 is subscribed can also deliver the emergency alert via the Internet 40 to the user device 32. This delivery can be performed in place of or as a supplement to providing the emergency alert simultaneously via Cell Broadcast.

The emergency alert may be transmitted in a number of formats. In one embodiment, the emergency alert is transmitted in a 90 character message consistent with CMAS messages delivered across Cell Broadcast distribution methods. One advantage to this arrangement is that all CMAMs are transmitted from the Federal Gateway 10 in this format. This is because the CMAS requirements specify that CMAMs must be sent in a text format which utilizes 90 characters or less. This specification is to satisfy limitations with certain Cell Broadcast variants. Providing the emergency alert may also include transmitting the same emergency alert in a more user friendly and rich format, e.g. messages longer than 90 characters, audio, images, video and multimedia, to the user device 32 via the Internet Protocol (IP) network, either as a supplement to, or as a substitute for the limited 90 character message. One advantage of this arrangement is that the user device 32 can receive a more detailed description of the emergency alert because the IP network does not share the limitations of the Cell Broadcast protocol.

The emergency alert may be provided to the user device 32 in a number of ways. For example, the emergency alert may be delivered to the user device 32 using a push protocol, which transmits the emergency alert to the user device 32 from the CMSP gateway 18. Alternatively, the user device 32 may be configured to periodically send a poll request to the CMSP gateway 18, which then transmits the emergency alert to the user device 32 in response to the poll request. In another embodiment, the user device 32 may be configured to receive alerts via IP Multicast. The CMSP gateway 18 and/or user device 32 can also switch between the push protocol and the polling request (or other) methods as needed if it is determined that a change is necessary.

The methods may be performed via a process that is not visible to a user of the user device 32, for example via a background process running on the user device 32 and/or the CMSP gateway 18. The process may be configured to run at startup of the user device 32 so that the process is always running when the user device 32 is turned on. The process may also be configured to re-launch itself in the event that the process crashes, stops responding or otherwise terminates.

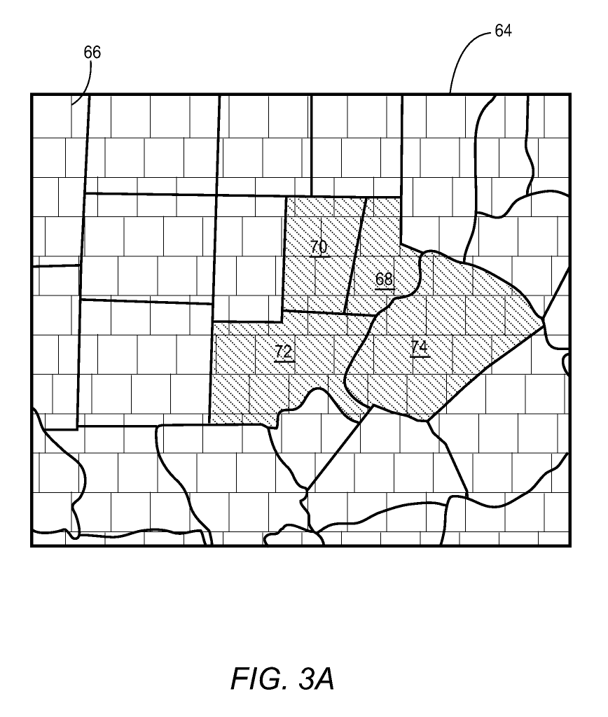

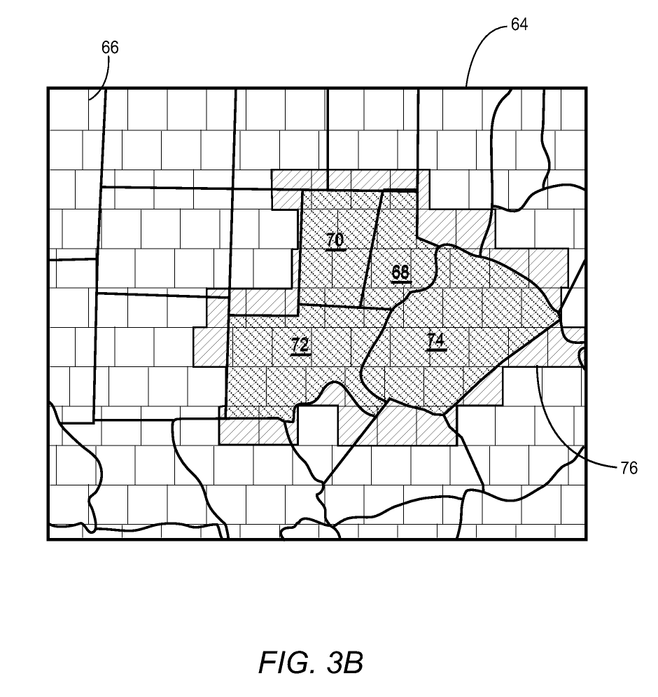

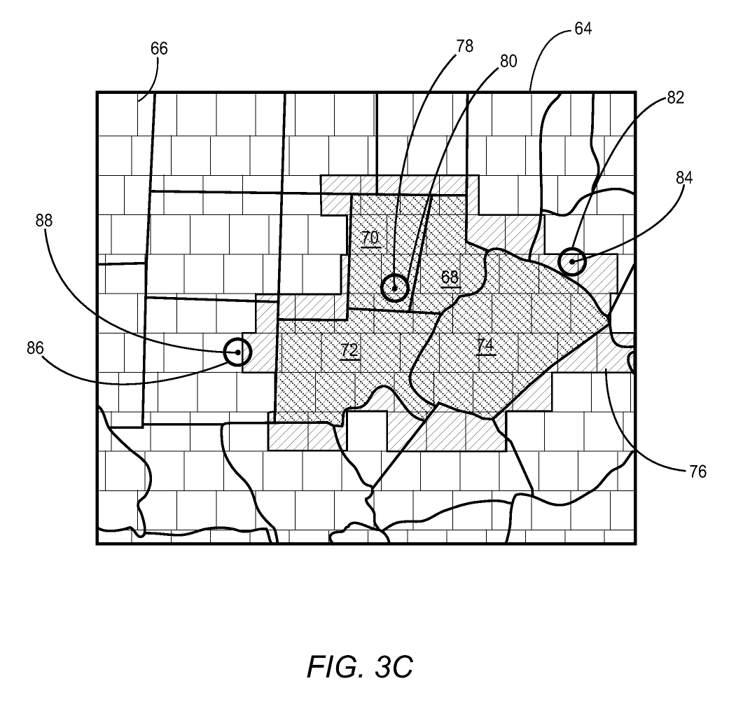

Turning now to FIGS. 3A-3C, the determination of a region to which an emergency alert is to be provided is determined, according to an exemplary embodiment. FIG. 3A illustrates a partial map of North Carolina divided by county. Arrays of equally sized shapes (such as squares are overlaid over the map. In this example, the east-west distance between any two longitudes becomes smaller as latitude increases away from the equator toward the North Pole or South Pole. Thus, in this example, each row of equally sized squares is slightly offset from the row below it. It should be understood that a variety of patterns may be used, including patterns of triangles, parallelograms, hexagons or other shapes. Alternatively, the pattern may be a regular grid pattern, such as a lattice pattern. The shapes can be any size, based on, for example, manageability of the data in each shape, and the precision desired in delivery. In one example, the squares are 5 km on each side. One advantage of this arrangement is that the larger geographic region can be divided up into equally spaced and sized sub-regions in a systematic way. In contrast, city, county and state boundaries can be irregular and, on their own, may make it difficult to determine with precision an appropriate region for an emergency alert. In this example, the county boundaries can be combined with the overlaid grid to quickly and efficiently determine an appropriate region for distributing the alert.

In this example, a CMAS alert has been generated for an emergency condition in Durham (68), Orange (70), Chatham (72) and Wake (74) counties, which are shaded in FIG. 3A. Turning now to FIG. 3B, all of the grid portions which contact these counties on the map have been darkened, establishing a single region 76 to which an emergency alert will be distributed. It should be noted that the county and other geographical boundaries may be combined with the grid or other pattern in a number of different ways, for example, based on whether it is desirable to be over- or under-inclusive in distributing emergency alerts. For example, the region to which the emergency alert will be distributed may be defined as only those grid sections that are located entirely within the counties 68, 70, 72, 74. This may be desirable when the emergency condition is more localized and it may not be necessary to notify users on the outskirts of the affected counties 68, 70, 72, 74.

Turning now to FIG. 3C, the specific user devices located substantially in the region 76 may now be identified. As with the combination of county lines and grid sections in FIG. 3B above, wireless nodes associated with the various user devices may be selected to be over- or under-inclusive as well. For example, while user devices associated with a tower 78, having a cell coverage area 80, located squarely within the region 76 will receive the emergency alert in any event, user devices outside of the region 76 but within a cell coverage area 82 of a tower 84, located within the region 76, may still receive the alert if desired. Likewise, user devices inside the region 76 but which are only within cell coverage area 86 of a tower 88 located outside the region 76 may not receive the emergency alert if desired. As with FIG. 3B, above, whether to be over- or under-inclusive in distributing the emergency alert can be adjusted based on the circumstances. For example, in an emergency situation, it may be desirable to be over-inclusive so as to ensure that the maximum number of user devices receives the emergency alert. When distributing the messages, the emergency alerts may be distributed across the IP network in waves to avoid congestion while systematically covering at least a portion of each grid section within the region 76 in each wave.

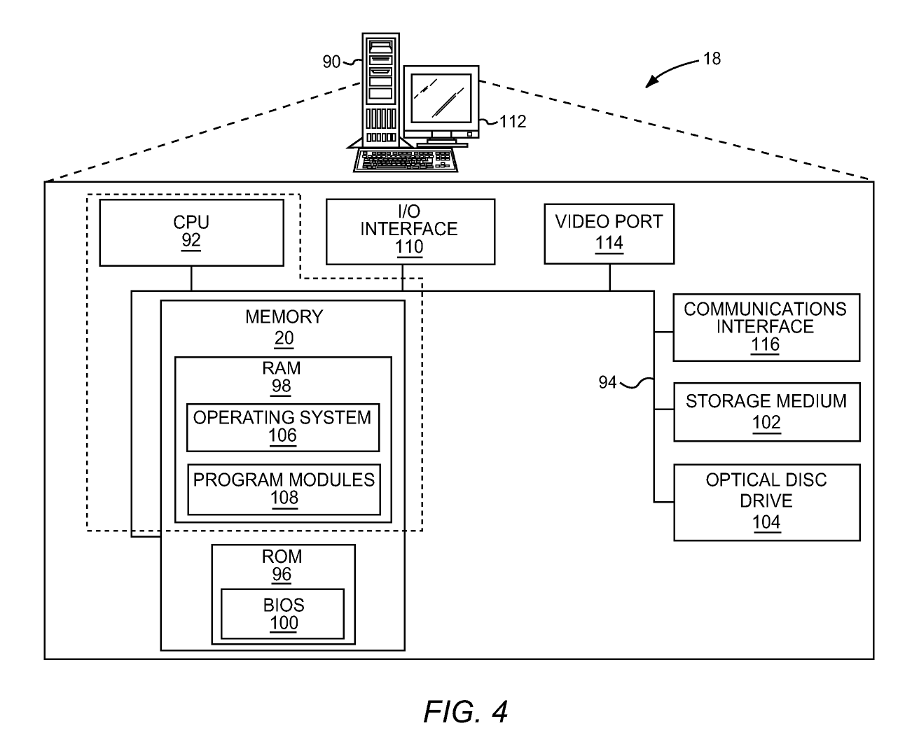

FIG. 4 illustrates an exemplary CMSP gateway 18 according to one embodiment. The CMSP gateway 18 may, as discussed previously, comprise one or more computing devices 90, such as a desktop computer or server computer, or the like. The CMSP gateway 18 can alternately run in one or more virtual machine (VM) environments. In addition to components discussed previously herein, the exemplary CMSP gateway 18 may include a central processing unit 92, a system memory 20, and a system bus 94. The system bus 94 provides an interface for system components including, but not limited to, the system memory 20 and the central processing unit 92. The central processing unit 92 can be any of various commercially available or proprietary processors. Dual microprocessors and other multi-processor architectures may also be employed as the central processing unit 92.

The system bus 94 can be any of several types of bus structures that may further interconnect to a memory bus (with or without a memory controller), a peripheral bus, and/or a local bus using any of a variety of commercially available bus architectures. The system memory 20 can include non-volatile memory 96 (e.g., read only memory (ROM), erasable programmable read only memory (EPROM), electrically erasable programmable read only memory (EEPROM), etc.) and/or volatile memory 98 (e.g., random access memory (RAM)). A basic input/output system (BIOS) 100 can be stored in the non-volatile memory 96, and can include the basic routines that help to transfer information between elements within the CMSP gateway 18. The volatile memory 98 can also include a high-speed RAM such as static RAM for caching data.

The CMSP gateway 18 may include a storage medium 102, which may comprise, for example, an internal hard disk drive (HDD) (e.g., enhanced integrated drive electronics (EIDE) or serial advanced technology attachment (SATA)), for storing various information including user device identification, network and location information. The CMSP gateway 18 may further include an optical disc drive 104 (e.g., for reading a CD-ROM or DVD-ROM). The drives and associated computer-readable media provide non-volatile storage of data, data structures, computer-executable instructions, and so forth. The drives and media accommodate the storage of any data in a suitable digital format. Although the description of computer-readable media above refers to an HDD and optical media such as a CD-ROM or DVD-ROM, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed CMSP gateway 18.

A number of program modules can be stored in the drives and volatile memory 98, including an operating system 106 and one or more program modules 108, which implement the functionality described herein, including, for example, distributing the emergency alerts, such as CMAS alerts. Such functionality may also be implemented by application-specific integrated circuits, hard-wired circuitry, or any combination thereof. It is to be appreciated that the embodiments can be implemented with various commercially available operating systems or combinations of operating systems. All or a portion of the embodiments may be implemented as a computer program product, such as a computer-usable or computer-readable medium having a computer-readable program code embodied therein. The computer-readable program code can include software instructions for implementing the functionality of the embodiments described herein. The central processing unit 92, in conjunction with the program modules 108 in the volatile memory 98, may serve as a control system for the CMSP gateway 18 that is configured to, or adapted to, implement the functionality described herein.

A user may be able to enter commands and information into the CMSP gateway 18 through one or more wired or wireless input devices, for example, a keyboard and a pointing device, such as a mouse (not illustrated). These and other input devices are often connected to the central processing unit 92 through an input/output interface 110 that is coupled to the system bus 94 but can be connected by other interfaces, such as a parallel port, an IEEE 1394 serial port, a universal serial bus (USB) port, an infrared (IR) interface, etc.

The CMSP gateway 18 may drive a separate or integral display 112, which may also be connected to the system bus 94 via an interface, such as a video port 114. The CMSP gateway 18 operates in a networked environment using a wired and/or wireless communications interface 116. The communications interface 116 can facilitate wired and/or wireless communications to the Internet 40, as well as other wired and wireless devices and nodes.

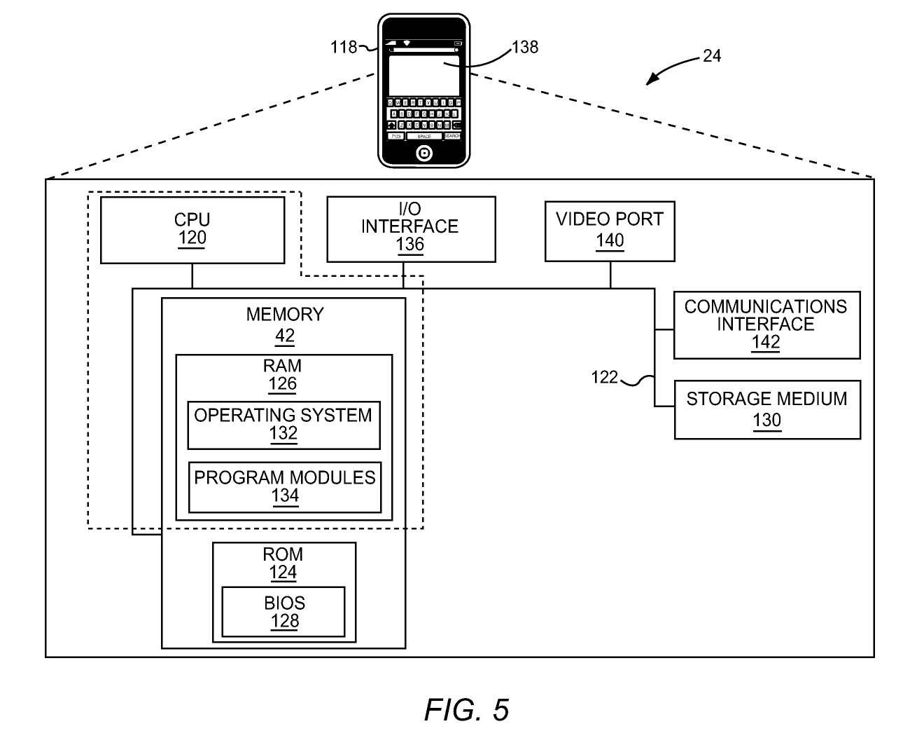

FIG. 5 illustrates an exemplary user device 24 according to one embodiment. The user device 24 may, as discussed previously, comprise a mobile computing device 118, such as a cellular phone, smartphone, tablet computer, laptop computer, wireless hotspot, or the like. In addition to components discussed previously herein, the exemplary user device 24 may include a central processing unit 120, a system memory 42, and a system bus 122. The system bus 122 provides an interface for system components including, but not limited to, the system memory 42 and the central processing unit 120. The central processing unit 120 can be any of various commercially available or proprietary processors. Dual microprocessors and other multi-processor architectures may also be employed as the central processing unit 120.

The system bus 122 can be any of several types of bus structures that may further interconnect to a memory bus (with or without a memory controller), a peripheral bus, and/or a local bus using any of a variety of commercially available bus architectures. The system memory 42 can include non-volatile memory 124 (e.g., read only memory (ROM), erasable programmable read only memory (EPROM), electrically erasable programmable read only memory (EEPROM), etc.) and/or volatile memory 126 (e.g., random access memory (RAM)). A basic input/output system (BIOS) 128 can be stored in the non-volatile memory 124, and can include the basic routines that help to transfer information between elements within the user device 24. The volatile memory 126 can also include a high-speed RAM such as static RAM for caching data.

The user device 24 may include a storage medium 130, which may comprise, for example, an internal hard disk drive (HDD) (e.g., enhanced integrated drive electronics (EIDE) or serial advanced technology attachment (SATA)) or other non-volatile storage such as flash memory, for storing various information, including user device identification, network and location information. The drives and associated computer-readable media provide non-volatile storage of data, data structures, computer-executable instructions, and so forth. The drives and media accommodate the storage of any data in a suitable digital format. Although the description of computer-readable media above refers to an HDD and flash memory, it should be appreciated by those skilled in the art that other types of media which are readable by a computer may also be used in the exemplary operating environment, and further, that any such media may contain computer-executable instructions for performing novel methods of the disclosed user device 24.

A number of program modules can be stored in the drives and volatile memory 126, including an operating system 132 and one or more program modules 134, which implement the functionality described herein, including, for example, determining throttling and routing strategies for the delivery of outgoing messages. Such functionality may also be implemented by application-specific integrated circuits, hard-wired circuitry, or any combination thereof. It is to be appreciated that the embodiments can be implemented with various commercially available operating systems or combinations of operating systems. All or a portion of the embodiments may be implemented as a computer program product, such as a computer-usable or computer-readable medium having a computer-readable program code embodied therein. The computer-readable program code can include software instructions for implementing the functionality of the embodiments described herein. The central processing unit 120, in conjunction with the program modules 134 in the volatile memory 126, may serve as a control system for the user device 24 that is configured to, or adapted to, implement the functionality described herein.

A user may be able to enter commands and information into the user device 24 through one or more built-in, wired or wireless input devices, for example, a touchscreen and/or a keyboard/keypad. These and other input devices are often connected to the central processing unit 120 through an input/output interface 136 that is coupled to the system bus 122 but can be connected by other interfaces, as discussed above.

The user device 24 may drive an integral (or external) display 138, which may also be connected to the system bus 122 via an interface, such as a video port 140. The user device operates in a networked environment using a wireless (or wired) communications interface 142. The communications interface 142 can facilitate wired and/or wireless communications to the Internet 40, as well as other wired and wireless devices and nodes.

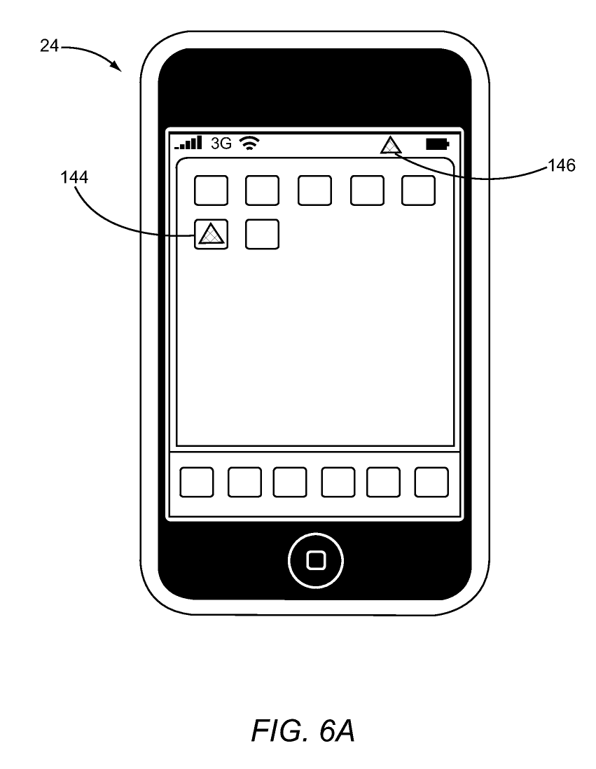

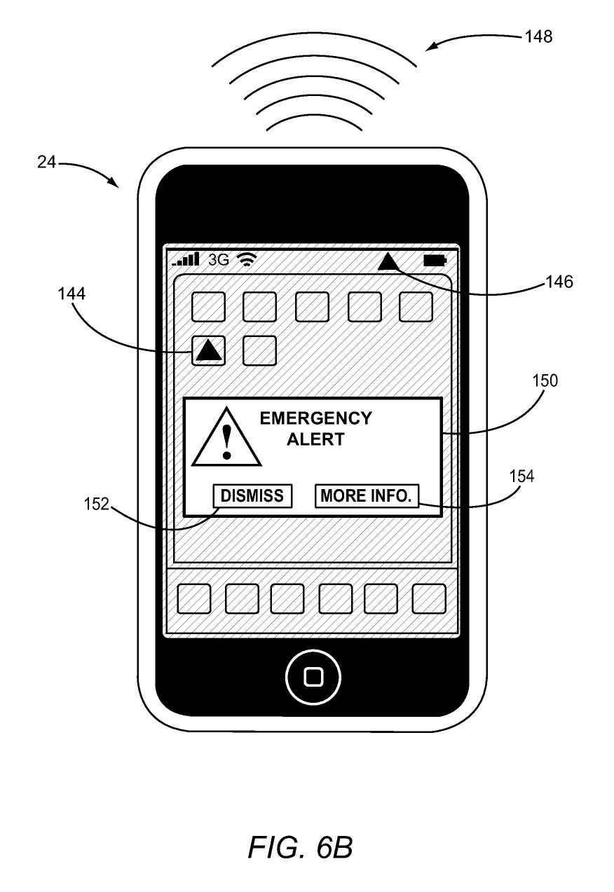

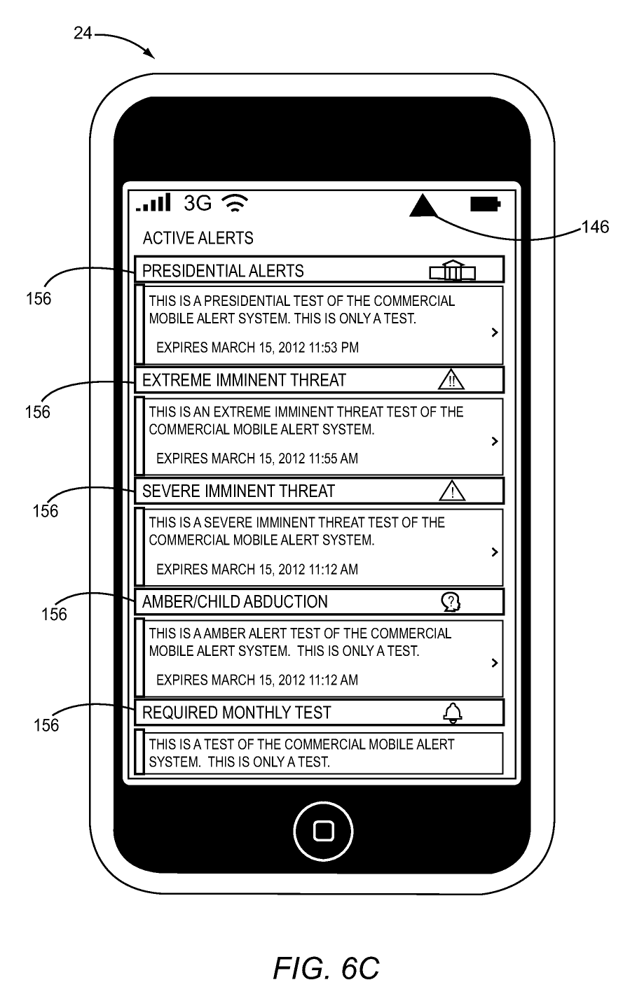

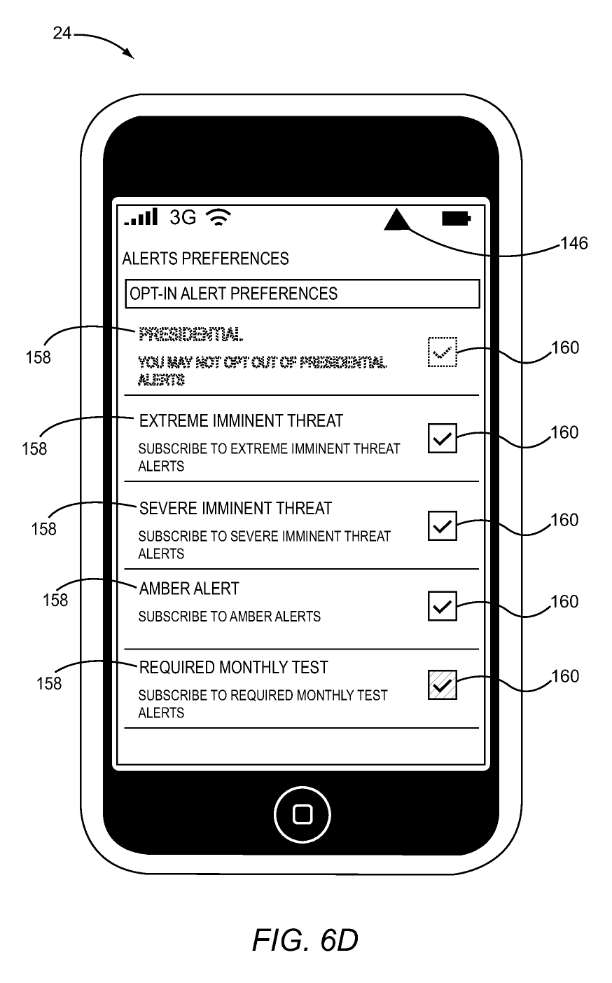

FIGS. 6A-6D illustrate a user interface for a user device 24 according to an exemplary embodiment. FIG. 6A illustrates details of the alert reception function 44, shown in FIG. 1, which may run as an application 144 on the user device 24 and/or as a background process that automatically receives and/or periodically polls for new emergency alerts. The application 144 can be preloaded on the user device 24 or may be downloaded by the user, for example, from an App Store. The background process can be invisible to a user or may be indicated as running by a status icon 146 or other indicator. When an emergency alert is received, as illustrated in FIG. 6B, the user device 24 can alert the user via a sound 148, vibration, graphical display or animation or other notification method. In one embodiment, the user device 24 displays a modal dialog 150 that floats above the user interface and contains information about the emergency alert. In this embodiment, the modal dialog 150 must be acknowledged and/or dismissed before the user is permitted to resume using the user device 24. The modal dialog 150 may include the entire message and/or a truncated version of the message, and may also include other information such as the category of message. The modal dialog 150 may also include an interface element 152 for dismissing the emergency alert notification and/or an interface element 154 for displaying additional information relating to the emergency alert. The additional information may be delivered to the user device 24 in conjunction with the emergency alert, or in response to a request from the user after receiving the emergency alert.

FIG. 6C illustrates a user interface for application 144 in which a list of one or more active emergency alerts 156 may be displayed on the user device 24. Each emergency alert 156 may be associated with an expiration date and/or time and upon expiration, may be removed from the list of active emergency alerts. In one embodiment, each emergency alert 156 may also be removed from the list by a user, and/or may be removed automatically upon a determination that the user device 24 is no longer within the affected region.

FIG. 6D illustrates another aspect of the user interface of application 144, in which one or more alert preference items 158 may be activated or deactivated. Activation/deactivation of each alert preference item 158 may be performed by the user, for example via a checkbox 160 associated with each alert preference item 158. In some embodiments, certain types of emergency alerts, e.g., presidential alerts, cannot be deactivated, for example because deactivation of these alerts are not permitted by rules regarding implementation of the CMAS protocol. Other options may also be selected, such as different ringtones or vibrations assigned to different types of emergency alerts.

Those skilled in the art will recognize improvements and modifications to the preferred embodiments of the present disclosure. All such improvements and modifications are considered within the scope of the concepts disclosed herein and the claims that follow.

What is claimed is:

1. A method of providing an emergency alert to a plurality of user devices comprising:
determining, at a gateway device, for each of the plurality of user devices, a network address that uniquely corresponds to the user device;
determining an emergency alert associated with a predetermined region;
determining a subset of the plurality of user devices located substantially in the predetermined region; and
providing the emergency alert to the subset of the plurality of user devices located substantially in the predetermined region via the network addresses of the subset of the plurality of user devices.

2. The method of claim 1, wherein providing the emergency alert comprises:
transmitting the emergency alert in a Cell Broadcast protocol-compatible 90 character message format to the user device via an Internet Protocol (IP) network.

3. The method of claim 2, wherein providing the emergency alert additionally comprises:
transmitting the emergency alert in a non-Cell Broadcast protocol-compatible format to the user device via the IP network.

4. The method of claim 1, further comprising, for each user device of the subset of the plurality of user devices:
determining whether the user device is in wireless communication with an Internet Protocol (IP) network, wherein providing the emergency alert to the user device via the IP network is in response to a determination that the user device is in wireless communication with the IP network; and
providing the emergency alert via a non-IP network in response to a determination that the user device is not in wireless communication with the IP network.

5. The method of claim 1, further comprising providing the emergency alert via a Cell Broadcast protocol.

6. The method of claim 1, wherein determining the subset of the plurality of user devices located substantially in the predetermined region comprises:
determining a location of each user device based on location data obtained from the user device.

7. The method of claim 1, wherein determining the subset of the plurality of user devices located substantially in the predetermined region comprises:
determining whether each user device is within a predetermined distance of a location of at least one wireless node.

8. The method of claim 7, wherein the at least one wireless node is a cellular tower.

9. The method of claim 7, wherein the at least one wireless node is a local wireless access point.

10. The method of claim 7, wherein determining whether each user device is within the predetermined distance of the location of the at least one wireless node comprises:
determining that the user device is in wireless communication with the at least one wireless node.

11. The method of claim 1, wherein the predetermined region is selected from a plurality of regions having substantially equal sizes and shapes.

12. The method of claim 11, wherein determining the subset of the plurality of user devices substantially located in the predetermined region comprises determining whether each user device is within a predetermined distance of a wireless node located in the predetermined region.

13. The method of claim 1, wherein the emergency alert is a Commercial Mobile Alerting System (CMAS) alert.

14. The method of claim 1, wherein providing the emergency alert to the user device via an Internet protocol (IP) network comprises transmitting the emergency alert to the user device via a push protocol.

15. The method of claim 1, wherein providing the emergency alert to the user device via an Internet protocol (IP) network comprises transmitting the emergency alert to the user device via an IP Multicast protocol.

16. The method of claim 1, wherein providing the emergency alert to the subset of the plurality of user devices is performed by a wireless carrier, and includes providing the emergency alert to one or more user devices that are not subscribed to the wireless carrier.

17. A method of receiving an emergency alert at a user device comprising:
in response to a determination at a gateway device that a subset of a plurality of user devices located in a predetermined region, each of the plurality of user devices having a network address uniquely associated with the user device;
receiving, via an Internet Protocol (IP) network, the emergency alert associated with the predetermined region that is transmitted by the gateway device via the IP network to the subset of the plurality of user devices in response to the determination that the subset of the plurality of user devices is located in the predetermined region.

18. The method of claim 17, wherein the determination at the gateway device that the subset of the plurality of user devices is located in the predetermined region is performed based on location data received from the subset of the plurality of user devices, wherein the location data corresponds to a location of the subset of the plurality of user devices.

19. The method of claim 17, wherein the determination at the gateway device that the subset of the plurality of user devices is located in the predetermined region is performed based on a determination that each of the subset of the plurality of user devices is within a predetermined distance of a location of a wireless node.

20. The method of claim 17, wherein the emergency alert is received by the subset of the plurality of user devices in a Cell Broadcast protocol-compatible 90 character message format.

21. The method of claim 17, wherein the emergency alert is received from a wireless carrier by the user device at a location outside of a service area of the wireless carrier.

22. The method of claim 17, wherein receiving the emergency alert is performed via a background process of the user device.

23. A method of receiving an emergency alert at a user device having a network address uniquely associated with the user device, comprising:
receiving, via an Internet Protocol (IP) network, an emergency alert associated with a predetermined region that is transmitted by a gateway device via the IP network to a plurality of user devices;
determining, at each user device, whether the user device is located in the predetermined region; and
in response to a determination that the user device is located in the predetermined region, providing the emergency alert to a user.

24. The method of claim 23, wherein determining whether the user device is located in the predetermined region comprises:
receiving information from the gateway device identifying the predetermined region.

25. The method of claim 24, wherein the information comprises a list of wireless nodes located in the predetermined region.

26. A gateway device configured to:
determine, for each of a plurality of user devices, a network address that uniquely corresponds to the user device;
determine an emergency alert associated with a predetermined region;
determine a subset of the plurality of user devices is located substantially in the predetermined region; and
provide the emergency alert to the subset of the plurality of user devices located substantially in the predetermined region via the network addresses of the subset of the plurality of user devices.

27. A user device configured to receive, via an Internet Protocol (IP) network, an emergency alert in response to a determination at a gateway device that a subset of a plurality of user devices located in a predetermined region, each of the plurality of user devices having a network address uniquely associated with the user device;
wherein the emergency alert is associated with the predetermined region that is transmitted by the gateway device via the IP network to the subset of the plurality of user devices in response to the determination that the subset of the plurality of user devices is located in the predetermined region.
